(19) United States
(12) Patent Application Publication
(10) Pub. No.: US 2021/0108815 A1
(43) Pub. Date: Apr. 15, 2021

(54) DISTRIBUTED HEATING AND COOLING SYSTEM AND METHOD

(71) Applicant: Robert T Boyer, Longmont, CO (US)

(72) Inventor: Robert T Boyer, Longmont, CO (US)

(21) Appl. No.: 16/596,760

(22) Filed: Oct. 9, 2019

(51) Int. Cl. F24F 11/30; F24F 3/044; F24F 7/08; F24F 11/56; F24F 11/64; F24F 11/65; F24F 11/72; F24F 11/80; F24F 11/77; G05B 15/02

(52) U.S. Cl. CPC F24F 11/30; F24F 3/044; F24F 7/08; F24F 11/56; F24F 11/64; F24F 2110/10; F24F 11/72; F24F 11/80; F24F 11/77; G05B 15/02; F24F 11/65

(57) ABSTRACT

A distributed heating and cooling system with air-duct, vent register or vent-diffuser based, collaborative fan devices to dynamically redistribute warmer or cooler air from a space, through an air-duct system of a building, into another space within the building so as to achieve the desired temperatures in the spaces to which these devices are connected. A bi-directional fan would move the air within a room into or out of an air-duct system. The system and method can create a multi-directional air flow within the building. Different fan devices work within different collaboration zones to create a distributed system for heating and cooling.

### TECHNICAL FIELD

A system and method for heating and cooling using temperature variances within a building and a distributed plurality of collaborative, vent register-based devices.

### BACKGROUND

Some buildings include a basement, at least partially below ground, which is cooler than the rest of the building. This is partially due to the nature of hot air rising to the upper floors (and the cold air descending into the basement) and due to the heat-sink effect in the basement concrete foundation. Many buildings, e.g., homes, only have a single thermostat, usually located on the main floor. Often, when air conditioning is applied, usually through a central, forced-air system, the upstairs are cooled and the basement becomes “freezing,” often to the extent of needing a space heater in the summer, even when the vent registers to such areas are closed or blocked. In the winter, in various geographic locations, the basement may conduct ground heat and be relatively warmer than the upper floors of a building exposed to the elements.

One attempted solution to balance the temperature in some central forced-air systems is to have a “fan” setting in which neither heating nor cooling is engaged. This circulates air within a building, but the effectiveness at achieving the right balance depends in part on where return-registers are found, and the temperature differentials. Often, such air circulation alone is insufficient.

Individual register or in-floor booster fans may assist the flow of air from the central system into a room. These fans are limited to the single air source and temperature being blown by the central system, which have no mechanisms to leverage temperate differences between multiple rooms or to drive a desired equilibrium.

A multi-zoned air conditioning system is relatively expensive and more so when retrofitting an existing system. Likewise, creating extensions for existing ductwork, building new ducts, or installing duct booster fans or dampers, can be expensive and cumbersome. Each zone will require separate thermostats, which can be set for different temperatures. Dampers may be installed inside the ductwork and be wirelessly connected to the thermostat. The damper can be a valve or plate that stops or regulates the flow of air inside a duct to direct the cooled air to different parts of the building. The damper may be used to cut off central heating or cooling to an unused room, or to regulate it for room-by-room temperature and climate control. The dampers will open and close based on instructions from the thermostat for a zone.

A ductless mini-split system is independent of normal central air systems. There is both an interior and exterior component that pulls in and cools the air from outside and directs the cooled air into the interior room. This requires installing flexible tubing within the home walls. A multi-zoned system can be created using several ductless mini-split systems. However, buildings with open floorplans and open stairwells will drain the cooler air into the basement.

Another system is disclosed in U.S. patent Ser. No. 10/309,685, to selectively use heat from a refrigeration sub-system to warm-up a customer environment. None of the aforementioned systems take a distributed approach of the present invention.

### SUMMARY

The present invention provides a distributed heating and cooling system to leverage temperature variances within a building.

One embodiment of a distributed heating and cooling system for a building comprises a plurality of fans deployed over a plurality of air-ducts, as vent registers or diffusers in individual rooms of the building to define separate collaboration zones for climate control, the vent registers being connected to a central system of air ducts in the building; a plurality of communication modules, wherein each communication module sends and receives information from at least one fan to the other fans to form a mesh network; a plurality of temperature sensors, wherein each temperature sensor measures the air temperature adjacent to at least one fan; a plurality of controllers, wherein each controller sets a desired set-point temperature for at least one fan; and a plurality of processors, wherein each processor determines for at least one fan based on the desired set-point temperature and the measured air temperature whether the at least one fan will operate to blow air into the air duct or allow air to exit the air duct through the vent-register associated with the fan in collaboration with the other fans in the same collaboration zone. In one embodiment, the fan also may include a bi-directional fan to blow air into or out from the air duct.

One method of distributed heating and cooling for a building comprises deploying a plurality of fans over a plurality of vent registers in individual rooms of a building, wherein the vent registers are connected to a central system of air ducts in the building; setting a desired temperature in at least one room of the building; measuring the air temperature adjacent to at least one of the fans; determining for each fan based on the desired temperature and the measured air temperature whether each fan will operate to blow air into the air duct or allow air to exit the air duct through the vent-register associated with the fan.

### BRIEF DESCRIPTION OF THE DRAWINGS

FIG. 1 shows a distributed heating and cooling system in one embodiment.

FIG. 2 shows an individual device in one embodiment.

FIG. 3 shows a multi-zone duct system and device allocation.

FIG. 4 is a flowchart of the algorithm run at each device that is used to control the device fan(s).

FIG. 5 shows a two-fan embodiment housed within a vent-register.

FIG. 6 shows an embodiment with an externally mounted, oversized fan.

### DETAILED DESCRIPTION OF EMBODIMENTS

In the following description and associated drawings, some conventional aspects of the best mode may be simplified or omitted. Those skilled in the art will appreciate that the features described below can be combined in various ways to form variations of the invention.

A distributed heating and cooling system is described that uses in-room vent registers coupled to wirelessly communicating, micro-computer controlled, fan (collectively the device), to create a collaborative network to determine whether each device should blow air into or out from the ducting system so to as to achieve a desired balance in each of the connected rooms. Electrical power, whether AC or DC, is considered to be available to power the device.

A distributed system can leverage the existing ductwork of the building without requiring access to the duct-work and can be used in conjunction with existing central Heating or Air Conditioner (A/C) system. Existing floor or ceiling air-vent registers can be swapped out with equivalently sized devices, each containing either a uni- or bi-directional fan, computing, data storage, and communications ability, and a digitally connected thermometer (wired or wireless), collectively referred to hereafter as a “device.” The devices communicate their temperature readings and needs with one another, internet of things (loT) style, or a central unit and determine which devices should activate, and which direction and with what force to blow air. Although the expected usage environment has temperature settings within a few degrees of one another, the distributed nature enables micro-zones with more varied temperatures.

One embodiment replaces existing vent registers with equivalently sized devices, but one alternate embodiment considers attaching a larger, external fan for greater airflow. Another embodiment only uses the devices networked together. An alternate embodiment leverages both the home heating/air-conditioning and dryer vent output as additional cooling or heat sources.

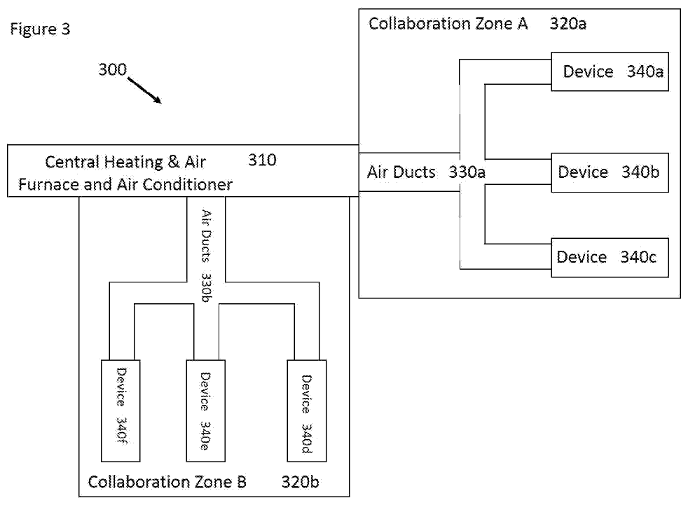

In one embodiment, a single-speed, bi-directional fan coupled with computational, communications, and temperature modules form a device. Each device is remotely configured to be in a collaboration zone (FIG. 3). Collaboration zone allows overlapping communications regions to remain functionally separate, but are expected to be attached to a single or severable ducting systems of the building. Each device is remotely configured with a target temperature, thus each device acts as an individual thermostat for the room. All devices within a collaboration zone are configured to blow from cool to warm regions or vice versa, where the configuration settings may change between winter and summer months.

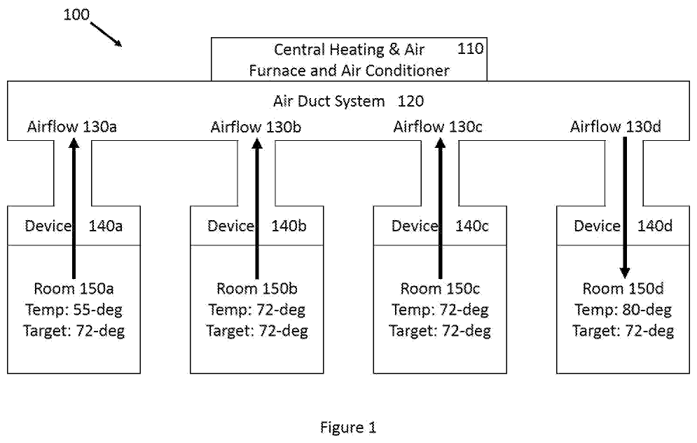

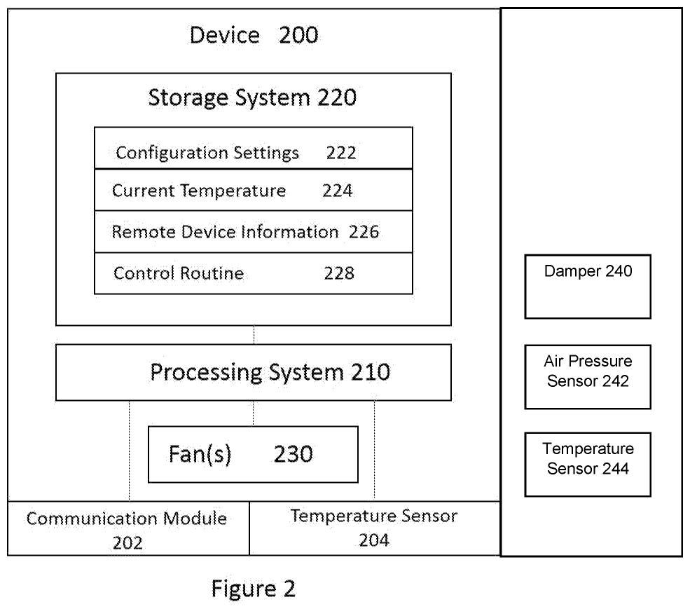

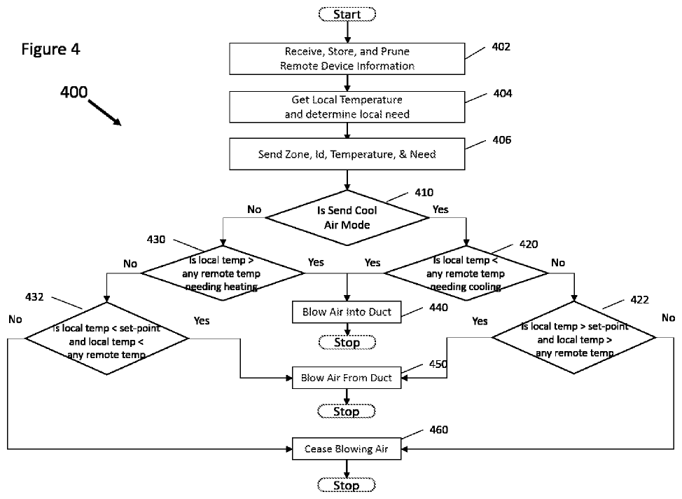

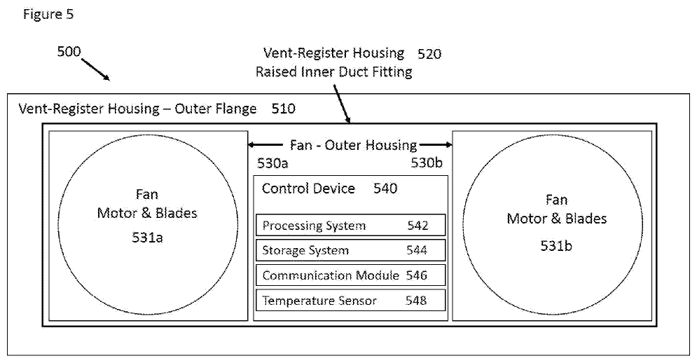

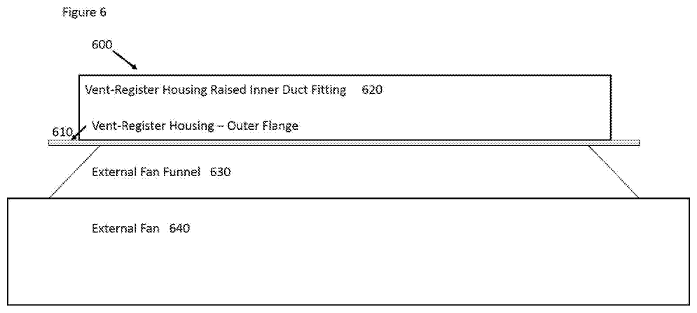

The heating/cooling process in a system (FIG. 1 and FIG. 3) is performed starting with all devices within a collaboration zone periodically, sharing their parameters, such as zone, device identifier, temperature reading, and temperature need, wirelessly with one another so as to determine temperature differences and needs. Each device (FIGS. 2, 5, and 6) then applies a device-specific algorithm (FIG. 4), based on the local temperature, identification of devices in need, and the device configurations to determine whether and how to activate the fan.

Alternate embodiments may use a single directional fan, multiple ‘coupled’ fans per register unit, multi-speed fans, external fans, or other air displacement means. The algorithms for such alternate embodiments vary accordingly.

Alternate embodiments may not support remote configuration, but may configure a device directly through a user interface on the device.

Alternate embodiments may use a more efficient single directional fan which may be manually reversed, e.g., via a mechanical, central pivot or a pivot on a track, with a mechanism to detect which direction the fan faces and an algorithm configured to support this variation.

Alternate embodiments may use an additional device or module as a central aggregator of device information and send only control information to the devices.

Alternate embodiments may use wired communications modules instead of wireless.

Alternate embodiments may support downloading new algorithms to the devices.

Alternate embodiments may be connected into the infrastructure of a smart home.

Alternate embodiments may allow for specific device fans to be turned off, to eliminate associated fan noise, while other fans may remain actively engaged.

Alternate embodiments may use different control algorithms, such as using an acceptable temperature range, i.e., low temperature and high temperature set-points, as compared to the single set-point described in the preferred embodiment.

FIG. 1 shows a distributed heating/cooling system 100 in one embodiment. The distributed heating/cooling system 100 includes existing artifacts of a central heating and air conditioning system, including the furnace and air conditioner 110, the air duct system 120, and the rooms 150a to 150d. The individual devices 140a to 140d are placed at the connection of the air duct system to the individual rooms, replacing the vent register. The plurality of devices 140 cause the airflow 130a to 130d based on the temperature desires across the multiple rooms.

FIG. 2 shows a device 200 in one embodiment, comprises a computerized device, with a processing system 210 and storage 220, which are coupled with a communication module 202 and a temperature sensor 204. That information and computational infrastructure is used to control the device fan(s) 230. The device 200 may further include an airflow pressure sensor 242 and damper 240 or other vent closure mechanism that is controlled based on data from the airflow pressure sensor 242 and the temperature sensor 204 or an optional air-duct temperature sensor 244.

An embodiment of the communication module 202 is a Bluetooth wireless low-energy unit as part of a mesh network. The communication module 202 comprises communication components, such as ports, signal processing circuitry, memory, software, and other elements as known to those skilled in the art. Alternative embodiments, such as wired or wireless home ethernet networks, e.g., IEEE 802.11, or a separate master control device providing point-to-point connections with each device, or other suitable communication mechanisms are also conceived. This module sends and receives data between all devices in the network, but keeps only data from devices within the same collaboration zone (FIG. 3).

The processing system 210 preferably comprises one or more microprocessors. The processing system 210 stores and retrieves the device configuration settings 222. The processing system 210 reads the current temperature sensor 204 and stores the current temperature 224 locally and reports out its information [zone, device identifier, temperature, and temperature need] to the communication module 202 to send as a message to the other devices. The processing system 210 receives and filters messages from the communication module 202 about the plurality of other devices and stores that information as remote device information 226. The processing system 210 executes the control routine 228 and uses the results to control the device fan(s) 230.

The storage system 220 comprises non-transitory, machine-readable, data storage media, such as flash drives, disc drives, memory circuitry, servers, and the like. The storage system 220 stores the device configuration settings 222, the current device temperature 224, remote device information 226, and the heating/cooling distributed algorithm 228. The remote device information 226 may include, for example, zone, device id, temperature, temperature need, and time of last reported information.

The control routine 228 comprises machine-readable instructions that control the operation of the processing system 210 when executed. The control routine 228 may also include operating systems, applications, utilities, databases, and the like. All or portions of the control routine 228 (and other data) may be externally stored on one or more storage media, such as flash drives, discs, servers, and other elements as known to those skilled in the art.

FIG. 3 shows a sample heating and cooling system 300 with the central heating and air conditioning 310 connected to segregated air duct subsystems 330a and 330b. Each separate air duct system would be contained by a separate collaboration zone 320a and 320b, respectively. Although the communication network may cause all devices 340 to receive all messages, each is configured to belong to a zone and to ignore messages from other zones. Within a single zone, e.g., Collaboration Zone A 320a, the devices 340a,b,c share their identity and other information so as to blow into or suck air from the associated air ducts 330a.

FIG. 4 is a flowchart 400 illustrating one embodiment of the heating/cooling algorithm. In this embodiment, this is performed by the control routine on each device.

In step 402, the device receives all remote device information and filters-out information from devices outside of its zone. The device stores remote device information for its collaboration zone, overriding any prior information from the same device, and then augments the information with the current time. Finally, the device prunes (deletes) information older than a configured time period, e.g., one-minute.

In step 404, the device retrieves its local measured temperature and determines its need. The need is calculated as configured set-point minus current measured temperature. Thus, a negative value indicates a desired lower temperature, a need for cooling, while a positive value indicates a desired higher temperature, a need for heating.

In step 406, the device sends out its configured zone and id, plus its current measured temperature and temperature change need. One embodiment sends the information periodically, at a configured rate, e.g., 20-seconds.

In step 410, the device checks its current configuration setting for whether the zone should be sending cool air (or warm air). If the device should be sending cool air, then the device goes to step 420. If the device should be sending warm air, then it goes to step 430.

In step 420, the device checks if its room is cool enough that it should blow air from the room into the duct system. This occurs if there exist one or more active devices with higher temperatures that have also indicated a need for cooling. A “yes” response leads to blow air into duct 440. A “no” response leads to step 422. For simplicity, the temperature sensors or the processing unit may round temperatures to the nearest whole degree, such that minor temperature deviations do not result in constant running of the device fans.

In step 422, the device checks if its room is warm enough that the device should be drawing cool air from the duct system. This occurs if the local temperature is above the set-point and there exist one or more active devices with lower temperatures than the local temperature. A “yes” response leads to blow air from duct 450. A “no” response leads to cease blowing air 460.

When 430 is reached, it has been determined the system is in a heating mode, that is, to blow warmer air around. In step 430, the device checks if its room is warm enough that the device should blow air from the room into the duct system. This occurs if there exist one or more devices with lower temperatures that have indicated a need for heating. A “yes” response leads to blow air into duct 440. A “no” response leads to step 432.

In step 432, the device checks if its room is cool enough that the device should be drawing warm air from the duct system. This occurs if the local temperature is below the set-point and there exist one or more devices with higher temperatures than the local temperature. A “yes” response leads to blow air from duct 450. A “no” response leads to cease blowing air 460.

One embodiment of this distributed heating/cooling system is not intended to directly heat or cool air, but to move air between rooms with different temperatures. One embodiment of the algorithm will be weighted to cool the warmest room (or warm the coolest room) before other rooms in a recursive manner. In a three-device environment, a device in need of cooling could still be sharing its air. Consider devices A, B, C with current temperatures 60°, 70°, and 80° Fahrenheit (or about 16°, 21°, and 27° Celsius), and target temperatures 55°, 65°, and 75° Fahrenheit (or about 13°, 18°, and 24° Celsius), respectively. The temperature in each room should be reduced by five degrees Fahrenheit (or about three degrees Celsius). The logic illustrated in FIG. 4 shows that devices A and B will blow their air into the duct system, even though their desired temperatures are below their current temperatures.

In situations where a forced-air system over-powers the fans in the vent registers, the cool air from the forced-air will, to an extent, take the path of least resistance, and thus first enter the rooms where the cool air is most desired because those vent fans are blowing the same direction. Where the static pressure is such that some air blows through vent fans going the opposite direction, when the thermostat controlling the forced-air system reaches the desired temperature, there may be excess cool air in some rooms, in which case the system will continue to perform its function as it was conceived.

One embodiment includes an additional air-duct temperature sensor 244, an airflow pressure sensor 242, and an automated vent closure mechanism or damper 240. The air-duct temperature sensor 244 is preferably directed to the air duct to detect an undesirable event (e.g., cooler than target), although temperature sensor 204 directed to the room may be used instead in the alternative as well. The airflow pressure sensor 242 detects the airflow and direction (which may require two airflow sensors). If the temperature (which may be as measured by air-duct temperature sensor 244 or temperature sensor 204) is undesirable and the flow is into the room, then the damper 240 would be triggered to close. Other alternate embodiments envision coupling a heater to the device.

Alternate embodiments envision hard-stop limits where, per the three-device example above, if a room temperature exceeds its desired temperature by a configured limit, e.g., over by seven degrees Fahrenheit (or about four degrees Celsius), a modified algorithm would allow it to cease blowing its cool air to another room in need. Another alternate embodiment envisions monitoring the rate of change within rooms and algorithms to leverage that information to control the fans or fan speeds.

Other embodiments envision integrating this invention with typical heating and air conditioning systems where the micro-zone temperature differentials could be incorporated into driving the main heating/air conditioning. And the temperature of the central air being blown into the duct system can be treated as an additional room and plugged into the algorithm as is.

Where there may be air leakage into rooms where the fan is off or under certain duct system configurations, this air leakage may not be significant and may be minimized by the air traveling pathways with the least resistance. Alternate embodiments may include self-sealing covers for when the air is off.

What is claimed is:

1. A distributed heating and cooling system for a building comprising:
a plurality of fans configured to be positioned over a plurality of air-ducts, as vent registers or diffusers, in rooms of the building to define separate collaboration zones for climate control, the vent registers being connected to a central system of air ducts in the building;
a plurality of temperature sensors, wherein each temperature sensor measures the air temperature adjacent to at least one fan;
a plurality of controllers, wherein each controller sets a desired set-point temperature for at least one fan;
a plurality of processors, wherein each processor determines for at least one fan based on the desired set-point temperature and the measured air temperature whether the at least one fan will operate to blow air into the air duct or allow air to exit the air duct through the vent register associated with the fan in collaboration with the other fans in the same collaboration zone;
a plurality of communication modules, wherein each communication module sends and receives information from at least one processor.

2. The system of claim 1, wherein each fan is uni-directional and blows air into the air-duct.

3. The system of claim 1, wherein each fan is bi-directional and may blow air into or out from the air-duct.

4. The system of claim 1, further comprising a central aggregator of information from the plurality of communication modules wherein the central aggregator sends instructions to the plurality of processors.

5. The system of claim 1, wherein each communication module sends and receives information from at least one processor to the plurality of processors to the other processors to form a mesh network.

6. The system of claim 1, wherein each processor is configured to filter out information regarding fans outside of a first collaboration zone for a first fan associated with the processor; store set-point information regarding the first collaboration zone for the first fan; delete information older than a predetermined time period; retrieve the measured air temperature adjacent to the first fan from the temperature sensor associated with the first fan; calculate a need value based on the set-point minus the measured temperature wherein a negative need value represents a need for cooling and a positive need value represents a need for heating; cause data representing a unique device identification, the collaboration zone, the measured temperature, and need value to be transmitted from the first fan to the other fans; check a configuration setting for the first collaboration zone; and cause air to be blown into the air duct if another fan in the first collaboration zone has transmitted a higher need.

7. The system of claim 1, further comprising an airflow pressure sensor positioned to detect an airflow direction through at least one of the vent registers, and a damper configured to close at least one of the vent registers if the detected airflow is deemed undesirable by the processor.

8. The system of claim 1, further comprising a plurality of housings configured to fit over one of the air-ducts, wherein each housing contains at least one of the fans, an external fan funnel, at least one of the communication modules, at least one of the temperature sensors, at least one of the controllers, and at least one of the processors, an airflow pressure sensor positioned to detect an airflow direction through at least one of the vent registers, and a damper responsive to the airflow pressure sensor.

9. A distributed heating and cooling system for a building comprising:
a plurality of air displacement means deployed over a plurality of air-ducts, as vent registers or diffusers, in individual rooms of the building to define separate collaboration zones for climate control, the vent registers being connected to a central system of air ducts in the building;
a plurality of temperature sensors, wherein each temperature sensor measures the air temperature adjacent to at least one air displacement means;
a plurality of controllers, wherein each controller sets a desired set-point temperature for at least one air displacement means;
a plurality of processors, wherein each processor determines for at least one air displacement means based on the desired set-point temperature and the measured air temperature whether the at least one air displacement means will operate to blow air into the air duct or allow air to exit the air duct through the vent-register associated with the air displacement means in collaboration with the other air displacement means in the same collaboration zone;
a plurality of communication modules, wherein each communication module sends and receives information from at least one processor.

10. The system of claim 9, wherein each processor filters out information regarding air displacement means outside of the collaboration zone for the air displacement means associated with the processor; stores set-point information regarding the collaboration zone for the air displacement means undergoing the determining step; deletes information older than a predetermined time period; retrieves the measured air temperature adjacent to the air displacement means from the temperature sensor associated with the air displacement means; calculates a need value based on the set-point minus the measured temperature wherein a negative need value represents a need for cooling and a positive need value represents a need for heating; causes data representing a unique device identification, the collaboration zone, the measured temperature, and need value to be transmitted from the air displacement means to the other air displacement means; checks a configuration setting for the collaboration zone; and causes air to be blown into the air duct if another air displacement means in the same collaboration zone has transmitted a higher need.

11. The system of claim 8, further comprising an airflow pressure sensor positioned to detect an airflow direction through at least one of the vent registers, and a damper configured to close at least one of the vent registers if the detected airflow is deemed undesirable by the processor.

12. A method of distributed heating and cooling for a building comprising:
deploying a plurality of fans over a plurality of air-ducts, as vent registers or diffusers, in individual rooms of a building, wherein the vent registers are connected to a central system of air ducts in the building;
setting a desired temperature in at least two rooms of the building;
measuring the air temperature adjacent to at least two of the fans;
determining for each fan based on the desired temperature and the measured air temperature whether each fan will operate to blows air into the air duct or allow air to exit the air duct through the vent register associated with the fan, and further configuring whether each of the fans in a collaboration zone will blow air into or out from the air ducts, such that the different desired temperatures are obtained in the separate collaboration zones.

13. The method of claim 11, wherein the fans are connected in a network, and the determining step for each fan further comprises:
filtering out information regarding fans outside of the collaboration zone for the fan undergoing the determining step;
storing set-point information regarding the collaboration zone for the fan undergoing the determining step;
deleting information older than a predetermined time period;
retrieving the measured air temperature adjacent to the fan from the measuring step;
calculating a need value based on the set-point minus the measured temperature, wherein a negative need value represents a need for cooling and a positive need value represents a need for heating;
transmitting data representing a unique device identification, the collaboration zone, the measured temperature, and need value from the fan to the other fans;
checking a configuration setting for the collaboration zone;
blowing air into the air duct if another fan in the same collaboration zone has transmitted a higher need.

14. The method of claim 11, wherein the fans are connected in a network, and the determining step for each fan further comprises:
filtering out information regarding fans outside of the collaboration zone for the fan undergoing the determining step;
storing set-point information regarding the collaboration zone for the fan undergoing the determining step;
deleting information older than a predetermined time period;
retrieving the measured air temperature adjacent to the fan from the measuring step;
calculating a need value based on the set-point minus the measured temperature, wherein a negative need value represents a need for cooling and a positive need value represents a need for heating;
transmitting data representing a unique device identification, the collaboration zone, the measured temperature, and need value from the fan to the other fans;
checking a configuration setting for the collaboration zone;
blowing air into the air duct if the configuration setting is for cooling and another fan in the same collaboration zone has transmitted a higher temperature than the local temperature and that fan has a need for cooling.

15. The method of claim 11, wherein the fans are connected in a network, and the determining step for each fan further comprises:
filtering out information regarding fans outside of the collaboration zone for the fan undergoing the determining step;
storing set-point information regarding the collaboration zone for the fan undergoing the determining step;
deleting information older than a predetermined time period;
retrieving the measured air temperature adjacent to the fan from the measuring step;
calculating a need value based on the set-point minus the measured temperature, wherein a negative need value represents a need for cooling and a positive need value represents a need for heating;
transmitting data representing a unique device identification, the collaboration zone, the measured temperature, and need value from the fan to the other fans;
checking a configuration setting for the collaboration zone;
blowing air into the air duct if the configuration setting is for cooling and another fan in the same collaboration zone has transmitted a higher temperature than the local temperature and that fan has a need for cooling;
blowing air out of the air duct if the configuration setting is for cooling, no other fan in the same collaboration zone has transmitted a higher need for cooling, and the measured temperature is higher than the stored set-point, and the measured temperature is higher than a temperature measured for another fan in the same collaboration zone.

16. The method of claim 11, wherein the fans are connected in a network, and the determining step for each fan further comprises:
filtering out information regarding fans outside of the collaboration zone for the fan undergoing the determining step;
storing set-point information regarding the collaboration zone for the fan undergoing the determining step;
deleting information older than a predetermined time period;
retrieving the measured air temperature adjacent to the fan from the measuring step;
calculating a need value based on the set-point minus the measured temperature, wherein a negative need value represents a need for cooling and a positive need value represents a need for heating;
transmitting data representing a unique device identification, the collaboration zone, the measured temperature, and need value from the fan to the other fans;
checking a configuration setting for the collaboration zone;
blowing air into the air duct if the configuration setting is for heating and another fan in the same collaboration zone has transmitted a lower temperature than the local temperature and that fan has a need for heating.

17. The method of claim 11, wherein the fans are connected in a network, and the determining step for each fan further comprises:
filtering out information regarding fans outside of the collaboration zone for the fan undergoing the determining step;
storing set-point information regarding the collaboration zone for the fan undergoing the determining step;
deleting information older than a predetermined time period;
retrieving the measured air temperature adjacent to the fan from the measuring step;
calculating a need value based on the set-point minus the measured temperature, wherein a negative need value represents a need for cooling and a positive need value represents a need for heating;
transmitting data representing a unique device identification, the collaboration zone, the measured temperature, and need value from the fan to the other fans;
checking a configuration setting for the collaboration zone;
blowing air into the air duct if the configuration setting is for heating and another fan in the same collaboration zone has transmitted a lower temperature than the local temperature and that fan has a need for heating;
blowing air out of the air duct if the configuration setting is for heating, no other fan in the same collaboration zone has transmitted a higher need for heating, and the measured temperature is lower than the stored set-point, and the measured temperature is lower than a temperature measured for another fan in the same collaboration zone.

18. The method of claim 11, wherein the determining step for each fan is performed by a processor associated with each fan and each processor is connected within a network.

19. The method of claim 11, wherein the determining step for each fan is performed by a central aggregator.

20. The method of claim 11, further comprising:
detecting an airflow direction through at least one of the vent registers using an airflow pressure sensor;
deciding whether the detected airflow direction is desirable based on the measured temperature;
closing at least one of the vent registers if the detected airflow is deemed undesirable in the deciding step.
